(19) United States
(12) Patent Application Publication
(10) Pub. No.: US 2026/0139137 A1
(43) Pub. Date: May 21, 2026

(54) ALL LIQUID, NON-FILLED AND HALOGEN FREE FIRE-RETARDANT THERMOSETTING COMPOSITIONS

(71) Applicant: AOC, LLC, Collierville, TN (US)

(72) Inventors: Edgardo M. Hernandez, Collierville, TN (US); Tim Austill, Collierville, TN (US); Francisco Daniel Rodriguez, Collierville, TN (US); Michael Siegel, Collierville, TN (US); Ron Verleg, Collierville, TN (US); Brian Robertson, Collierville, TN (US)

(73) Assignee: AOC, LLC, Collierville, TN (US)

(21) Appl. No.: 19/120,962

(22) PCT Filed: Oct. 16, 2023
(86) PCT No.: PCT/US2023/035238

§ 371 Date: Apr. 14, 2025

Related U.S. Application Data
(60) Provisional application No. 63/416,287, filed on Oct. 14, 2022.

(51) Int. Cl. C08L 35/02; C08K 5/101; C08K 5/5419; C08L 67/00; C08L 75/04; C08L 85/02

(52) U.S. Cl. CPC C08L 35/02; C08K 5/101; C08K 5/5419; C08L 67/00; C08L 75/04; C08L 85/02

(57) ABSTRACT

A series of all-liquid, non-filled and halogen free fire-retardant thermosetting resins are herein reported. These compositions provide good physical and mechanical performance while providing inherent nonflammability. The resins systems are designed to eliminate exposure to toxic gases such as halogen halides which are commonly produced during combustion. In addition, due their mechanical performance these materials are capable of excellent performance under high pressure and temperature environments such as those seen by battery enclosures during runaway reactions. In general, these compositions showcase novel fire-retardant resins capable of reducing the risks associated with fires and their byproducts without compromising the utility and performance of such.

### CROSS REFERENCE TO RELATED APPLICATIONS

This nonprovisional application claims the benefit of priority under 35 USC § 119 to U.S. Patent Application No. 63/416,287, filed on Oct. 14, 2022, the entirety of which is incorporated herein by reference.

### BACKGROUND OF THE INVENTION

### Field of the Invention

The present invention pertains to all-liquid and non-filled halogen free fire-retardant thermosetting compositions. In a more specific illustration, this invention relates to the use of said thermosetting compositions for mass transportation and related applications. Similarly, this invention also relates to a process for the manufacture of these resin compositions.

### Description of the Background

Currently, most fire-retardant thermosetting resins depend on the use of halogenated materials and/or inert fillers such as aluminum trihydrate to perform satisfactorily. Unfortunately, these materials present challenges such as the evolution of highly toxic gases during combustion. In addition, they can have reduced processability hindering their use in many applications or processes. For example, halogenated thermosetting resins derived from tetrachlorophthalic anhydride, tetrabromophthalic anhydride, chlorendic anhydride, dibromoneopentyl glycol, and tetrabromobisphenol A have excellent fire-retardant characteristics but yield corrosive hydrogen halide gases upon combustion. Separately, many of the prior art resins have limited photostability and high specific gravity which is a disadvantage for building applications. In general, these issues preclude the use of these resins on mass transportation and other applications.

The primary fillers used in prior art flame retardant thermosetting resins based on inert fillers include aluminum trihydrate, melamine, calcium sulfate and/or calcium carbonate. The main disadvantages of these materials are the high specific gravity and high viscosity shown by resins incorporating them. This is undesirable from a processing perspective since it limits the types of processes through which these resins can be employed. As in the case of halogenated resins, these highly filled prior art systems also suffer from limited photostability and weathering deficiencies in general.

Separately, some existing thermosetting resins with fire retardant properties belong to a class known as intumescent resins. Intumescent materials are those which have the capacity to expand as they are heated above a certain temperature. During the burning process, an insulating layer is formed on the material thus preventing thermal propagation further into the composite part. It is well understood that for this subclass of fire-retardant materials to work as intended several components are needed. One of these components is a polyhydroxy material (or derived from) such as sugars, trimethylolpropane, and pentaerythritol among others. These materials should be in general, capable of being dehydrated to produce a carbonaceous layer.

Another required component for an intumescent resin is a phosphorus compound capable of producing phosphoric acid upon heating. Phosphoric acid is a powerful dehydrating substance and thus will interact accordingly with the polyhydroxy substances above. Lastly, the intumescent resin system requires nitrogen containing materials which will contribute expansive gases during their decomposition.

Exemplary prior art intumescent resin compounds rely on significant amounts of filler, and thus also suffer the aforementioned drawbacks of high specific gravity, high viscosity, limited photostability, and weathering deficiencies. For example, PCT Application Publication No. WO 97/31056 (“Weil”), proposes that the use of an unsaturated polyester resin in combination with solid melamine and a phosphorus compound exhibits self-extinguishing properties and low smoke evolution. However, the compounds disclosed by Weil rely on significant amounts of melamine, in combination with ammonium polyphosphate, both fillers which suffer from some of the above drawbacks, as a flame retardant. PCT Application Publication No. WO 2020/025845 (“Nogués”) also illustrates that the use of unsaturated polyester resins and vinyl ester resins derived compositions could provide significant fire protection in combination with a gelcoat using ammonium polyphosphate (APP) and melamine. The compositions disclosed by Nogués also contain pentaerythritol, which serves as a source of carbonaceous material.

Accordingly, a fire-retardant thermosetting resin that does not rely on the use of fillers, and is halogen-free, would be an improvement over the prior art, in order to limit the emission of corrosive and/or toxic gasses, including halogen halides, during combustion. Moreover, a fire-retardant thermosetting resin that does not rely on the use of fillers, and is halogen-free, would also have the benefits of a lower specific gravity and viscosity, and improved photostability, which would enable them to be used in building, transportation, and like applications.

### SUMMARY OF THE INVENTION

The present invention is a series of novel all-liquid, non-filled and halogen-free fire-retardant thermosetting resins for general composite applications, particularly mass transportation related ones. The present invention includes a series of resin compositions manifestly composed of an unsaturated polyester resin, a urethane (meth)-acrylate resin, a liquid oligomeric phosphonate, a reactive liquid melamine derivative, a flexible liquid polyurethane, and a combination of vinyl and (meth)-acrylate reactive monomers.

Accordingly, an object of this invention is to provide an (a) all-liquid, (b) non-filled and (c) halogen-free thermosetting resins compositions with mechanical and physical properties suitable for use general composite applications.

Another object of this invention is to provide thermosetting resins capable of being cured using thermal initiation at both low temperature or high temperatures.

Another object of this invention is to provide a thermosetting resin scaffold capable of providing fire protection by using varied sources of nitrogen materials such urethane (meth)-acrylates and liquid melamine derivatives, among others.

Another object of this invention is to provide a fire-retardant thermosetting resins capable of passing stringent testing such as Docket 90 which includes ASTM E-162 Flame Spread, ASTM E-662 Smoke Test, and BSS 7239 Gas Toxicity among others.

Another object of this invention is to provide a fire-retardant thermosetting resins capable of fulfilling the requirements of UL 2596 as it pertains to the thermal and mechanical performance of battery enclosure materials.

These and other objects, features and advantages of this invention will become apparent with reference to the following embodiments.

### DETAILED DESCRIPTION OF THE PREFERRED EMBODIMENTS

As noted above, present invention is a class of resin compositions which comprise or consist essentially of, in preferred embodiments, one or more of the following elements: (A) an unsaturated polyester resin, (B) a urethane (meth)-acrylate resin, (C) a liquid oligomeric phosphonate, (D) a reactive liquid melamine derivative, (E) a flexible liquid polyurethane, and (F) one or more reactive monomers, such as vinyl reactive monomers (F1), (meth)-acrylate reactive monomers (F2), or a combination of both (F1) and (F2). The inventive composition may also utilize one or more optional additives.

In embodiments, the inventive composition utilizes either (A) an unsaturated polyester resin or (B) a urethane resin, or both an unsaturated polyester resin and a urethane resin, in combination with one or more of the other components noted above. In embodiments, the total amount of resin in the inventive composition is in the range of 0-35%, or 10-35%. In some embodiments, the total amount of resin in the inventive composition is in the range of 15-33.6%.

In embodiments, the unsaturated polyester resin (A) used in the inventive compounds can be a dicyclopentadiene (DCPD) modified unsaturated polyester resin. In some preferred embodiments, the unsaturated polyester resin (A) is made from a DCPD terminated unsaturated polyester resin used in combination with a nitrogen rich compound and a liquid phosphorus compound.

As used herein, the term urethane (meth)-acrylate refers to the product of the reaction between an isocyanate and capable acrylate and/or methacrylate moieties. In embodiments, the urethane (meth)-acrylate resin (B) used in the inventive composition can the product of the reaction between an aromatic difunctional isocyanate and a hydroxy functionalized (meth)-acrylate. In embodiments, the urethane (meth)-acrylate resin (B) used in the inventive composition can be a methylene diphenyl diisocyanate (MDI) derived urethane methacrylate.

Also in some preferred embodiments, the liquid phosphorus component (C) of the inventive compounds is an oligomeric phosphonate and/or a polyphosphonate. In embodiments, component (C) can be one or more compounds selected from the list comprising: Phosphonic Acid, Methyl-(5-Ethyl-2-Methyl-2-Oxido-1,3,2-Dioxophospho); Phosphonic acid, P-methyl-, diphenyl ester, polymer with 4,4′-(1-methylethylidene)bis[phenol]; or phosphonicacid, methyl-, bis[(5-ethyl-2-methyl-2,2-dioxido-1,3,2dioxaphosphorinan-5-yl)methyl]esterwith (5-ethyl-2-methyl-2-oxido-1,3,2dioxaphosphorinan-5-yl)methylmethyl methylphosphonate. In embodiments, the total amount of liquid oligomeric phosphonate (C) in the inventive composition is in the range of 3-15%. In some embodiments, the total amount of liquid oligomeric phosphonate (C) in the inventive composition is in the range of 4-12%. The percentages for each component referenced herein are to be understood as representing the weight % of each component in the formulation.

Also as used herein, the term reactive liquid melamine derivative refers to a melamine derived material containing vinyl and/or (meth)-acrylate groups covalently bonded making it capable of copolymerizing with said resin. In some embodiments, the reactive liquid melamine derivative component (D) can be a melamine acrylate and/or a melamine triacrylate. In embodiments, the amount of reactive liquid melamine derivative (D) in the inventive composition can be in the range of 0-50%. In some embodiments, the amount of reactive liquid melamine derivative (D) in the inventive composition can be in the range of 0-45%, or 40-45%.

The flexible liquid polyurethane (E) used according to the present invention can be a compound such as an aliphatic urethane trifunctional acrylate oligomer composition. In some embodiments, the amount of flexible liquid polyurethane (E) in the inventive composition can be in the range of 10-40%. In some embodiments, the amount of flexible liquid polyurethane (E) in the inventive composition can be in the range of 15-35%.

As used herein, the term (meth)-acrylates refers to reactive diluents such as acrylates and methacrylates with various degrees of functionalization. In certain embodiments, the vinyl and/or (meth)-acrylate reactive monomers (F) according to the present invention can include methyl (meth)-acrylate, 2-Hydroxyethyl (meth)-acrylate, Hydroxypropyl (meth)-acrylate, Trimethylolpropane triacrylate (TMPTA), and/or a combination of Tris(2-hydroxy Ethyl)isocyanurate triacrylate with trimethylolpropane triacrylate. In embodiments, the total amount of vinyl and (meth)-acrylate reactive monomers (F) in the inventive composition can be in the range of 30-40%. In some embodiments, the total amount of vinyl and (meth)-acrylate reactive monomers (F) in the inventive composition can be in the range of 34-36%.

In embodiments, the inventive compound may employ additives such as defoamers, air release additives, bonding or coupling agents, including silane coupling agents, such as Trimethoxyvinylsilane, preservatives, such as copper 8% naphthenate, and others known in the art.

Also in embodiments, the inventive compound may employ one or more reactive diluents, such as cyclohexanedicarboxyimide ethylacrylate. Cyclohexanedicarboxyimide ethylacrylate is preferred in certain embodiments due to its nitrogen content. The present inventors have found that, as compared with other materials in this class, nitrogen and phosphorous containing materials provide better fire retardant performance in combination with the other components in the inventive formulations.

Moreover, it will be understood that the relative quantities of certain classes of materials described with respect to the inventive formulations may not encompass the amount of such classes of composition in the base resin formulations, or in another component which is separately listed in the example formulations. For example, the DCPD Unsaturated Polyester used in example formulations 1 and 2 below comprises 28% styrene, and a Urethane Methacrylate component may comprise 15% methyl methacrylate (MMA) and 15% 2-hydroxyethylmethacrylate (HEMA).

Although formulations comprising one or more of the above compounds, or types of compounds, all fall within the scope of the present invention, preferred embodiments of the present invention each include three primary classes of materials, in combination with one or more of the remaining classes of materials and/or one or more additives. The primary classes of materials included in each of the preferred embodiments of the present invention are:
(1) a polyphosphonate (C), such as a liquid oligomeric phosphonate;
(2) a reactive polyurethane (E), such as a flexible liquid polyurethane; and
(3) at least one reactive monomer (F) of the vinyl or (meth)-acrylate type.

The present inventors have found that a surprisingly positive fire-retardant effect has been achieved with each of these primary three components in formulation.

In particular, the present inventors have found that a surprisingly positive fire-retardant effect has been achieved when the total % of reactive monomer (F) in the formulation is between 34-36%, or between 34.11 and 35.34%. In preferred embodiments, the at least one reactive monomer in the formulation includes 2-hydroxyethyl methacrylate (HEMA). In some preferred embodiments, the at least one reactive monomer in the formulation includes a combination of HEMA and trimethyolpropane triacrylate (TMPTA). In other preferred embodiments, the at least one reactive monomer in the formulation includes a combination of HEMA, methyl-methacrylate (MMA), TMPTA and Tris(2-Hydrocy ethyl) Isocyanurate Triacrylate.

Moreover, the present inventors have found that a surprisingly positive fire-retardant effect has been achieved when the amount of polyphosphonate (C) is between 4-10%, or between 4.87-10%. In preferred embodiments, the polyphosphonate (C) used in the inventive formulations includes a compound formed from the reaction of Phosphonic Acid and Methyl-(5-Ethyl-2-Methyl-2-Oxido-1,3,2-Dioxophospho).

Further still, the present inventors have found that a surprisingly positive fire-retardant effect has been achieved when the ratio of component (C) to component (F), i.e., the ratio of polyphosphonate to reactive monomer, in the formulation is between 1:3 and 1:8, or between 1:3.5 and 1:7.17.

In addition, the present inventors have found that a surprisingly positive fire-retardant effect has been achieved when the inventive formulations contain reactive polyurethane (E) in an amount of between 16-35%, or between 17.04 and 34.5%.

### Example Formulations

Without limiting the generality of the foregoing, exemplary formulations are provided in Tables 1-3 to illustrate certain embodiments of the present invention.

TABLE 1
Example Formulation 1

| Ingredient | % |
|---|---|
| DCPD Unsaturated polyester resin | 15.00 |
| Aliphatic Trifunctional Urethane Acrylate | 34.50 |
| Cyclohexanedicarboxyimide ethylacrylate | 5.00 |
| (Meth)-acrylate | 15.00 |
| (Mixture of TMPTA and Tris(2-Hydrocyethyl) | |
| Isocyanurate Triacrylate) | |
| Polyphosphonate | 10.00 |
| (Phosphonic Acid, Methyl-(5-Ethyl-2- | |
| Methyl-2-Oxido-1,3,2-Dioxophospho)) | |
| Methyl methacrylate | 10.00 |
| 2-Hydroxyethyl methacrylate | 10.00 |
| Byk A-500 | 0.10 |
| Trimethoxyvinylsilane | 0.40 |
| Total | 100.00 |

TABLE 2
Example Formulation 2

| Ingredient | % |
|---|---|
| DCPD Unsaturated polyester resin | 14.80 |
| Aliphatic Trifunctional Urethane Acrylate | 20.72 |
| MDI derived urethane methacrylate | 18.76 |
| Cyclohexanedicarboxyimide ethylacrylate | 4.93 |
| (Meth)-acrylate | 19.74 |
| (Mixture of TMPTA and Tris(2-Hydrocyethyl) | |
| Isocyanurate Triacrylate) | |
| Polyphosphonate | 4.93 |
| (Phosphonic Acid, Methyl-(5-Ethyl-2- | |
| Methyl-2-Oxido-1,3,2-Dioxophospho)) | |
| Methyl methacrylate | 8.42 |
| 2-Hydroxyethyl methacrylate | 7.18 |
| Byk A-500 | 0.10 |
| Trimethoxyvinylsilane | 0.40 |
| Total | 100.00 |

TABLE 3
Example Formulation 3

| Ingredient | % |
|---|---|
| Melamine Triacrylate | 43.83 |
| Aliphatic Trifunctional Urethane Acrylate | 17.04 |
| Byk A-500 | 0.10 |
| Polyphosphonate | 4.87 |
| (Phosphonic Acid, Methyl-(5-Ethyl-2- | |
| Methyl-2-Oxido-1,3,2-Dioxophospho)) | |
| 2-Hydroxyethyl methacrylate | 19.01 |
| TMPTA | 15.10 |
| Copper 8% Naphthanate | 0.0037 |
| Diallyldimethylammonium chloride | 0.0450 |
| Butylated hydroxytoluene | 0.0120 |
| Total | 100.00 |

### Results: Fire-Retardant Testing of Inventive Formulations

The inventive example formulations 1-3, described above, were tested for fire, smoke and toxicity performance according to the known Docket 90 testing protocol (for demonstrating materials safety with respect to flammability and smoke emission characteristics in transit applications), which includes ASTM E-162 Flame Spread, ASTM E-662 Smoke Test, and BSS 7239 Gas Toxicity.

As can be seen from the rest results presented in Tables 4-6, below, the inventive compositions, illustrated here by the example formulations 1-3, each showed good physical and mechanical performance while providing inherent nonflammability. In particular, the mechanical performance demonstrated by the inventive compounds makes them suitable for high pressure and temperature environments, such as in battery enclosures during runaway reactions. The ability of the inventive compositions to be used in such applications is a distinct improvement over prior art fire retardant compositions. Moreover, the present invention is particularly novel in that it is an all liquid, halogen-free resin composition which is capable of passing the UL 2596 testing protocols (Test Method for Thermal and Mechanical Performance of Battery Enclosure Materials), demonstrating that the inventive composition is able to be used in battery enclosures and is safe in thermal runaway events.

In general, the inventive compositions showcase novel fire-retardant resins capable of reducing the risks associated with fires and their byproducts without compromising the utility and performance of such. The results illustrated below for all three Example Formulations indicate that the resins passed each of the tests in the Docket 90 protocol (ASTM E-162 Flame Spread, ASTM E-662 Smoke Test, and BSS 7239 Gas Toxicity), with the volume of released gasses (each within the acceptable margin) for the BSS 7239 Gas Toxicity test are reported in the bottom half of each of Tables 4-6.

TABLE 4
Fire, Smoke and Toxicity (FST) Docket
90 Test Results - Example Formulation 1

| Test | Result | |
|---|---|---|
| ASTM E-162 Flame Spread | 14 | |
| ASTM E-662 Smoke | 155 | |
| BSS 7239 Gas Toxicity | Passed | |
| Carbon Monoxide (4′ Flame) | 944 | ppm |
| Hydrogen Cyanide (4′ Flame) | 10 | ppm |
| Hydrogen Fluoride (4′ Flame) | >2.0 | ppm |
| Hydrogen Chloride (4′ Flame) | >1.0 | ppm |
| Sulfur Dioxide | 22 | ppm |
| Nitrous gases | 32.5 | ppm |

TABLE 5
Fire, Smoke and Toxicity (FST) Docket
90 Test Results - Example Formulation 2

| Test | Result | |
|---|---|---|
| ASTM E-162 Flame Spread | 8 | |
| ASTM E-662 Smoke | 109 | |
| BSS 7239 Gas Toxicity | Passed | |
| Carbon Monoxide (4′ Flame) | 102 | ppm |
| Hydrogen Cyanide (4′ Flame) | 5 | ppm |
| Hydrogen Fluoride (4′ Flame) | >2.0 | ppm |
| Hydrogen Chloride (4′ Flame) | >1.0 | ppm |
| Sulfur Dioxide | 0 | ppm |
| Nitrous gases | 11 | ppm |

TABLE 6
Fire, Smoke and Toxicity (FST) Docket
90 Test Results - Example Formulation 3

| Test | Result | |
|---|---|---|
| ASTM E-162 Flame Spread | 8.4 | |
| ASTM E-662 Smoke | 121 | |
| BSS 7239 Gas Toxicity | Passed | |
| Carbon Monoxide (4′ Flame) | 135.5 | ppm |
| Hydrogen Cyanide (4′ Flame) | 7.5 | ppm |
| Hydrogen Fluoride (4′ Flame) | >2.0 | ppm |
| Hydrogen Chloride (4′ Flame) | >1.0 | ppm |
| Sulfur Dioxide | 0 | ppm |
| Nitrous gases | 34.6 | ppm |

### Results: Thermal and Mechanical Performance of Battery Enclosure Materials

To further illustrate the novel, and improved, features of the inventive formulations over the prior art, example formulation 2, disclosed above, was next tested in a thermal runaway box using the testing protocol of UL 2596. This test simulates a battery enclosure with 25 electrochemical cells undergoing a violent reaction and thus the battery enclosure should remain as a whole part during the process. The testing protocol calls for the ensemble to have a 16 mm pinhole allowing the runaway reaction to reach a certain pressure and temperature. In this test, a laminate with 67% glass content and 3.75 mm was made using formulation 2. This laminate was then placed on top electrochemical cells to simulate an enclosure. Finally, the electrochemical cells were intentionally heated leading to an unstable state in which these cells enter a self-heating thermal runaway reaction. As the thermal runaway progresses, the cells produce heat faster than it can be dissipated. This may lead to fire, explosion, and gas evolution. To the knowledge of the present inventors, no other liquid, non-filled and halogen-free thermoset resin has successfully passed the UL 2596 testing protocol.

As shown in Table 7, below, the enclosure comprising the inventive compositions showed acceptable suppression of the runaway reaction, while maintaining physical and mechanical performance in a way not feasible using known prior art flame retardant resins. In particular, the battery enclosure incorporating Example Formulation 2 satisfied the requirements of UL 2596, as it pertains to the thermal and mechanical performance of battery enclosure materials, while showing fire retardant properties, and without relying on fillers or halogen-comprising materials.

TABLE 7
UL 2596 Battery enclosure with 16 mm pinhole runaway test

| | | 250 kPa | | Peak |
|---|---|---|---|---|
| | | (16 mm) | | Temperature |
| | | Peak | | (° C. @ |
| Resin | Specimen | Pressure | Ignition* | seconds) |
| Example | #1 @ 3.79 mm | 155.4 | No | 331.5 @ 297″ |
| Formulation 2 | | | | |
| Example | #2 @ 3.74 mm | 220.8 | No | 378.9 @ 272″ |
| Formulation 2 | | | | |
| Example | #3 @3.78 mm | 150.2 | No | 378.8 @ 330″ |
| Formulation 2 | | | | |

This application is therefore intended to cover any variations, uses, or adaptations of the invention using its general principles. Further, this application is intended to cover such departures from the present disclosure as come within known or customary practice in the art to which this invention pertains.

### STATEMENT OF INDUSTRIAL APPLICABILITY

The present invention incorporates a class of thermosetting compositions which have applications for mass transportation and related applications. In particular, the present invention relates to one or more thermosetting compositions which incorporate novel fire-retardant resins capable of reducing the risks associated with fires and their byproducts without compromising the utility and performance of such.

We claim:

1. A non-filled and halogen-free fire-retardant thermosetting resin consisting essentially of:
one or more resins;
a liquid oligomeric phosphonate;
a reactive liquid melamine derivative;
a flexible liquid polyurethane; and
one or more monomers selected from the group comprising vinyl and (meth)-acrylate reactive monomers.

2. The non-filled and halogen-free fire-retardant thermosetting resin of claim 1, wherein said one or more resins includes an unsaturated polyester resin and a urethane (meth)-acrylate resin.

3. The non-filled and halogen-free fire-retardant thermosetting resin of claim 1, wherein said one or more resins consists of an unsaturated polyester resin.

4. The non-filled and halogen-free fire-retardant thermosetting resin of claim 1, wherein said one or more resins consists of a urethane (meth)-acrylate resin.

5. The non-filled and halogen-free fire-retardant thermosetting resin of claim 1, further comprising one or more additives.

6. The non-filled and halogen-free fire-retardant thermosetting resin of claim 1, wherein said one or more resins are present in said thermosetting resin in a range of 10-20%.

7. The non-filled and halogen-free fire-retardant thermosetting resin of claim 1, wherein said liquid oligomeric phosphonate is present in said thermosetting resin in a range of 3-15%.

8. The non-filled and halogen-free fire-retardant thermosetting resin of claim 1, wherein said reactive liquid melamine derivative is present in said thermosetting resin in a range of 40-45%.

9. The non-filled and halogen-free fire-retardant thermosetting resin of claim 1, wherein said one or more monomers are present in said thermosetting resin in a range of 30-40%.

10. The non-filled and halogen-free fire-retardant thermosetting resin of claim 1, wherein the resin comprises:
a polyphosphonate;
a reactive polyurethane; and
at least one reactive monomer selected from the group comprising vinyl and (meth)-acrylate reactive monomers.

11. The non-filled and halogen-free fire-retardant thermosetting resin of claim 10, wherein the at least one reactive monomer includes 2-hydroxyethyl methacrylate (HEMA).

12. The non-filled and halogen-free fire-retardant thermosetting resin of claim 10, wherein the at least one reactive monomer in the formulation includes a combination of 2-hydroxyethyl methacrylate (HEMA) and trimethyolpropane triacrylate (TMPTA).

13. The non-filled and halogen-free fire-retardant thermosetting resin of claim 10, wherein the at least one reactive monomer includes a combination of 2-hydroxyethyl methacrylate (HEMA), methyl-methacrylate (MMA), trimethyolpropane triacrylate (TMPTA) and Tris(2-Hydrocy ethyl) Isocyanurate Triacrylate.

14. The non-filled and halogen-free fire-retardant thermosetting resin of claim 10, wherein the total weight % of the at least one reactive monomer is between 34% and 36%.

15. The non-filled and halogen-free fire-retardant thermosetting resin of claim 10, wherein the amount of polyphosphonate is between 4 wt % and 10 wt %.

16. The non-filled and halogen-free fire-retardant thermosetting resin of claim 15, wherein the polyphosphonate comprises a compound formed from the reaction of Phosphonic Acid and Methyl-(5-Ethyl-2-Methyl-2-Oxido-1,3,2-Dioxophospho).

17. The non-filled and halogen-free fire-retardant thermosetting resin of claim 10, wherein the ratio of polyphosphonate to reactive monomer in the formulation is between 1:3 and 1:8.

18. The non-filled and halogen-free fire-retardant thermosetting resin of claim 15, wherein the ratio of polyphosphonate to reactive monomer in the formulation is between 1:3 and 1:8.

19. The non-filled and halogen-free fire-retardant thermosetting resin of claim 10, wherein the amount of reactive polyurethane is between 16 wt % and 35% wt %.

20. The non-filled and halogen-free fire-retardant thermosetting resin of claim 10, wherein the reactive polyurethane is aliphatic trifunctional urethane acrylate.
